(19) United States
(12) Patent Application Publication
(10) Pub. No.: US 2026/0316837 A1
(43) Pub. Date: Oct. 15, 2026

(54) BODY SUBFRAME FOR HYBRID OR ELECTRIC VEHICLE EQUIPPED WITH REINFORCED LATERAL SPARS

(71) Applicant: Stellantis Auto SAS, Poissy (FR)

(72) Inventor: Damien Bessette, Ecot (FR)

(21) Appl. No.: 18/879,612

(22) PCT Filed: Jun. 6, 2023
(86) PCT No.: PCT/FR2023/050799

§ 371 Date: Dec. 27, 2024

(30) Foreign Application Priority Data
Jul. 19, 2022 (FR) FR2207385

(51) Int. Cl. B62D 21/15; B60K 1/04

(52) U.S. Cl. CPC B62D 21/157; B60K 1/04; B60K 2001/0411; B60K 2001/0438

(57) ABSTRACT

The invention relates to a body subframe (2) for a hybrid or electric motor vehicle, comprising a floor (3) extending transversely between two subframe lateral spars (10) and at least one seat crossmember (8, 9) fixed to the top of said floor and extending transversely between said two lateral spars, to which it is fixed; each said lateral spar comprising an elongate hollow body of closed cross section composed of an internal spar part (12) and an external spar part which are fixed to each other, each lateral spar also comprising an inner reinforcement extending longitudinally along and inside its hollow body; characterized in that each said lateral spar additionally comprises an outer reinforcement (15) fixedly attached against the outer face of a zone of said internal spar part situated opposite the at least one seat crossmember

### CROSS-REFERENCE TO RELATED APPLICATIONS

The present application is the US National Stage under 35 USC § 371 of PCT/FR2023/050799, which claims the priority of French application 2207385 filed on Jul. 19, 2022, the content (text, drawings and claims) of both said applications being incorporated by reference herein.

### BACKGROUND

The present disclosure relates generally to the body subframe of hybrid or electric motor vehicles equipped with a traction battery. In particular, it concerns a body subframe with reinforced lateral spars.

A hybrid or electric motor vehicle comprises an electric motor and, optionally, a combustion engine coupled to the electric motor. At least one traction battery is also provided in such a vehicle to power the electric motor.

The body subframe of such a hybrid or electric vehicle typically comprises a front floor extending longitudinally between the front apron and the rear floor, and transversely between two body subframe lateral spars.

Such a subframe lateral spar generally comprises an elongated hollow body of closed cross-section and comprises of an internal spar part and an external spar part attached to each other.

The body subframe further comprises at least one front seat crossmember attached to the top of the front floor and extending transversely between the two subframe lateral spars below the first row of seats.

The subframe lateral spars and the front seat crossmember(s) contribute to the rigidity of the body subframe and, in the event of a side impact, effectively limit the dynamic intrusion of the doors into the vehicle interior.

Indeed, in the event of such a side impact, a large proportion of the resulting forces pass through these elements, which are dimensioned accordingly.

In the event of a side impact with a pole, and more particularly when this impact is caused to the traction battery of a hybrid or electric vehicle, even slight denting of the corresponding lateral spar caused by crushing of the seat crossmember(s) can lead to deformation of the traction battery and damage to some of its electrochemical cells, creating a risk of electrocution or chemical burns for passengers.

In order to reduce the forces exerted on the seat crossmembers(s) so as to limit the denting of the lateral spar in the event of such a side impact, it is known, in particular from document FR3081418A1, to provide an inner reinforcement extending longitudinally along the hollow body of each subframe lateral spar.

Such an inner reinforcement is designed to crush itself against the internal part of the hollow spar body to absorb a significant portion of the impact energy and thus limit the forces transmitted to the crossmember(s).

Unfortunately, side impact test protocols show that this inner reinforcement only partially crushes due to the excessive deformation of the internal part of the hollow spar body caused by the corresponding end(s) of the seat crossmember(s).

### SUMMARY

To overcome the above noted issues, disclosed is a body subframe for a hybrid or electric motor vehicle, comprising a floor extending transversely between two subframe lateral spars and at least one seat crossmember fixed to the top of the said floor and extending transversely between said two lateral spars, to which it is fixed; each said lateral spar comprising an elongate hollow body of closed cross-section composed of an internal spar part and an external spar part secured together, each said lateral spar also comprising an inner reinforcement extending longitudinally along and inside its hollow body;

wherein lateral spar further comprises an outer reinforcement fixedly attached to the outer face of a zone of said internal spar part located opposite said at least one seat crossmember.

In the event of a side impact, the addition of such an external spar reinforcement limits the deformation of the internal part of the hollow spar body caused by the corresponding end(s) of the seat crossmember(s), so as to optimize the crushing of the inner reinforcement against the internal part and maximize the absorption of the energy of this impact by this inner reinforcement.

The residual forces transmitted to the seat crossmember(s) are thus considerably reduced, which considerably limits the crushing of the crossmember(s) and therefore the risk of deformation of the vehicle's traction battery.

In addition, the fact that this outer reinforcement extends only over a zone of the internal spar part limits the increase in mass of the lateral spar. The lateral spar also makes it possible to keep the same part number for the internal and external lateral spar parts of all versions of the same vehicle model, whether or not they are fitted with a traction battery (as the lateral spars of non-hybrid or electric versions lack inner and outer reinforcements).

According to preferred features of said body subframe:
the part of each said lateral spar has a cross-sectional profile in the shape of a recumbent U and comprises a lateral web and two upper and lower plates extending away from said floor from this lateral web, said outer reinforcement of each said lateral spar having a cross-sectional profile in the shape of an inverted L and comprising a lateral flange bearing against the outer face of said lateral web and an upper flange extending away from said floor from this lateral web and bearing against the outer face of said upper plate;
each end of said at least one seat crossmember is attached to the corresponding lateral spar by means of lugs projecting transversely from said end and welded to the upper flange of the outer reinforcement of that spar;
the lateral flange of each said outer reinforcement extends vertically on either side of said floor over at least the majority of the height of the lateral web of the internal part of the corresponding spar;
the outer reinforcement of each said lateral spar has cut-outs made in certain respective zones of the internal part of this spar provided with attachment holes;
the outer reinforcement of each said lateral spar is obtained from a sheet of double-phase steel plate with a thickness of between 1.5 and 2.5 millimeters;
the inner reinforcement of each said lateral spar is made of a metal section obtained by extrusion;
the inner reinforcement of each said lateral spar has a honeycomb structure comprised of an outer shell and a network of internal partitions crisscrossing the inner volume of that shell; and/or
said subframe comprises two crossmembers spaced longitudinally from one another.

In a second aspect, a motor vehicle comprising such a body subframe is also disclosed.

### BRIEF DESCRIPTION OF THE FIGURES

The disclosure will now be continued with the detailed description of an exemplary embodiment, given hereinafter by way of illustration but not limitation, with reference to the appended drawings, in which:

FIG. 1 shows a partial perspective view of the body structure of a hybrid or electric vehicle comprised of a body subframe, with two lateral spars laterally bordering a front floor;

FIG. 2 is an exploded perspective view of one of the two lateral spars of the body subframe shown in FIG. 1;

FIG. 3 shows a perspective view, from another angle, of the lateral spar of FIG. 2 in an assembled configuration; and

FIG. 4 is a perspective view of the outer reinforcement one of the two lateral spars of the body subframe shown in FIG. 1.

### DETAILED DESCRIPTION

FIG. 1 is a partial view of a body structure 1 of a hybrid or electric motor vehicle.

A direct orthogonal reference frame XYZ is defined with respect to this vehicle, comprising three axes perpendicular to each other, namely:
a horizontal longitudinal axis X, parallel to the ground and oriented in the general direction of travel of the vehicle;
a horizontal transverse axis Y, also parallel to the ground and perpendicular to the X axis; and
a vertical axis Z, perpendicular to the ground and to the horizontal plane XY.

In the following description and by convention, the terms “lower”, “upper”, “front” and “rear” will be understood in relation to the general orientation of the vehicle. The terms “lower” and “down” will indicate greater proximity to the ground in the vertical direction than “upper” or “up”. The term “front” indicates a position facing the front of a vehicle in the horizontal direction, and the term “rear” indicates a position facing the rear of a vehicle in the same horizontal direction.

The terms “external” and “internal” are used to define the relative position of a component with respect to the vehicle's longitudinal centerline. The element closest to this axis will thus be referred to as internal, as opposed to the other element further away, which will be referred to as external.

Furthermore, the term “substantially” will be used to indicate that a slight deviation from a predetermined nominal position or arrangement is permissible, while remaining within the scope of the claimed invention. For example, “substantially vertical” will indicate that a deviation of the order of 20° from a strictly perpendicular orientation is permissible within the scope of the claimed invention.

With reference to FIG. 1, the body structure 1 comprises a body subframe 2 comprising a front floor 3 extending longitudinally between the front apron 4 and the rear floor 5 designed to support the rear seats (also known as “second-row seats”), and transversely between two subframe lateral spars 10 (only the left lateral spar 10 being visible in this FIG. 1).

A middle pillar 6 separating the front and rear side doors connects each lateral spar 10 to a corresponding roof side frame 7 of the vehicle (only the left middle pillar 6 and a portion of the left roof side frame 7 are shown in FIG. 1).

A traction battery, not visible in FIG. 1, is also located under the vehicle's front floor 3, between the two body subframe lateral spars 10.

The body subframe 2 also comprises two longitudinally spaced metal seat crossmembers 8, 9, which are attached to the top of the front floor 3 and extend transversely between the two body subframe lateral spars 10, to which they are also attached.

The first seat cross-member 8 is in line with the two middle pillars 6, while the second 9 is in front of them.

Exhibiting an inverted U-shaped cross-section (i.e. open at the bottom), these front seat crossmembers 8, 9 constitute anchoring supports for the seat reinforcements of the front seats by means of two pairs of slides not shown, each comprising, in a conventional manner, a lower rail, the two ends of which are respectively attached to one and the other of these crossmembers 8, 9, and an upper rail slidably mounted on the lower rail and rigidly connected to a corresponding lower lateral part of the seat frame of a corresponding seat.

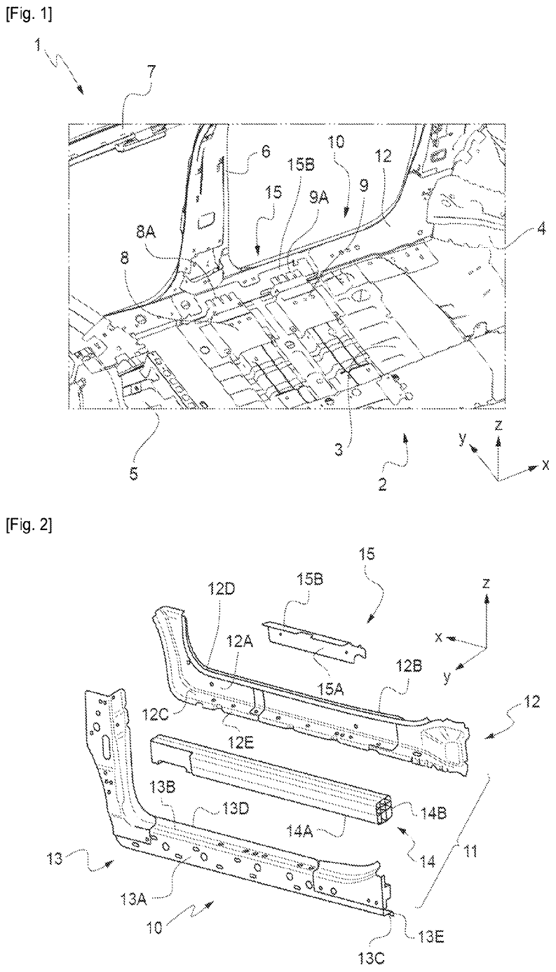

Referring to FIG. 2, each subframe lateral spar 10 comprises an elongated hollow body 11 of closed cross-section delimiting an inner cavity of substantially square cross-section, this hollow body comprised of an internal spar part 12 and an external spar part 13.

These internal 12 and external 13 parts forming the hollow body 11 are each obtained by stamping from one or more sheets of metal, preferably dual-phase steel sheets, advantageously with a thickness of between 1.2 and 1.4 millimeters.

The internal part 12 of each lateral spar 10 has a substantially U-shaped cross-section, with the opening facing away from the front floor 3 of the vehicle to which it is attached. This internal part 12 comprises a substantially vertical lateral web 12A and two upper 12B and lower 12C plates extending substantially horizontally away from the front floor 3 from that lateral web 12A. The upper plate 12B and lower plate 12C each extend away from the lateral web 12A into an upper joining rabbet 12D and a lower joining rabbet 12E respectively, which are bent outwards from the U.

Similar in construction to the internal part, the external part 13 of each lateral spar 10 has a cross-sectional profile substantially in the shape of a recumbent U, with the opening facing the front floor 3 of the vehicle. This external part 13 comprises a substantially vertical lateral web 13A and two upper 13B and lower 12C plates extending substantially horizontally toward the front floor 3 from that lateral web 13A.

The upper 13B and lower 13C plates each extend away from the lateral web 13A into an upper joining rabbet 13D and a lower joining rabbet 13E respectively, which are bent outwards from the U.

The internal 12 and external 13 parts of each spar 10 are fastened together by welding their upper 12D, 13D joint rabbets and their lower 12E, 13E joint rabbets.

Each spar 10 further comprises an inner reinforcement 14 extending longitudinally along and inside said hollow body 11 to which it is rigidly attached.

In this case, the inner reinforcement of spar 14 comprises a metal section, preferably obtained by extrusion and advantageously made of aluminum or an aluminum alloy.

With a substantially rectangular or square cross-section and occupying most of the interior volume of the hollow body 11, the internal spar reinforcement 14 has a honeycomb structure comprised of an outer shell 14A with a rectangular cross-section and a network of internal partitions 14B crisscrossing the interior volume of this shell 14A.

Each lateral spar 10 also comprises an outer reinforcement 15 fixedly attached to the outer face of a central zone of the internal part 12 of the hollow body 11 of the lateral spar 10, located opposite the corresponding lateral ends of the two front seat crossmembers 8, 9.

The outer reinforcement 15 of each spar 10 is cold-formed from a sheet of metal, preferably dual-phase steel (e.g. DP 780), advantageously with a thickness of between 1.5 and 2.5 millimeters.

Exhibiting an inverted L-shaped cross-sectional profile, each outer reinforcement 15 comprises a substantially vertical lateral flange 15A affixed against the outer face of the lateral web 12A of the internal part 12 of the hollow body 11 of the corresponding spar 10, as well as an upper flange 15B extending substantially horizontally away from the front floor 3 from the lateral web 15A and being affixed against the outer face of the upper plate 12B of the internal part 12.

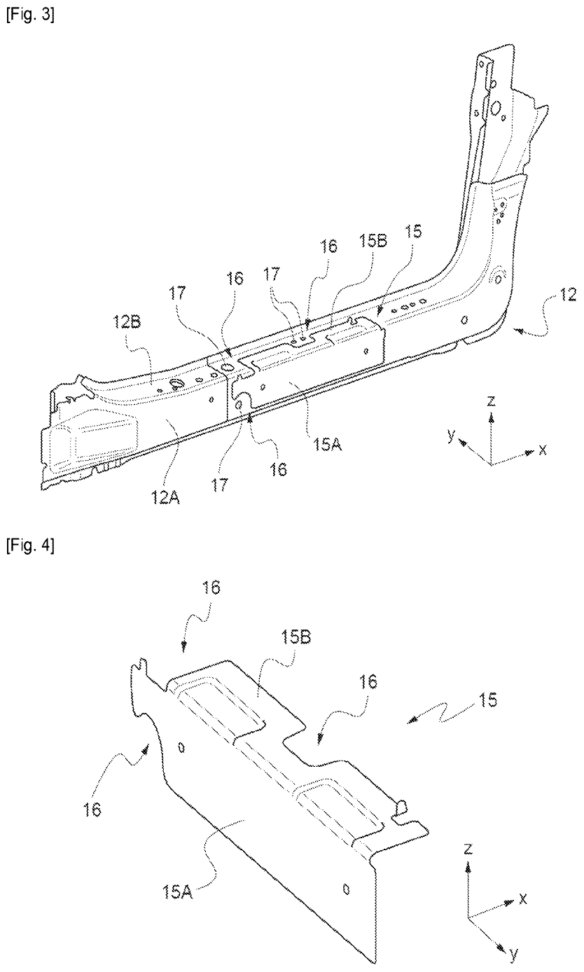

Advantageously, and as shown in FIG. 3, the lateral flange 15A of each said outer reinforcement 15 extends vertically on either side of the front floor 3 over at least the majority of the height of the lateral web 12A of the internal part 12 of the corresponding spar 10.

Its upper flange 15B extends transversely over at least the majority of the upper flange width 12B of the internal part 12 of the corresponding spar 10.

As shown in FIG. 1, each lateral end of the seat crossmembers 8, 9 is attached to the corresponding lateral spar 10 by means of tabs 8A, 9A projecting transversely from said end and welded to the upper flange 15B of the outer reinforcement 15 of this lateral spar 10.

As shown in FIGS. 3 and 4, the outer reinforcement 15 of each lateral spar 10 advantageously features a number of cut-outs 16 made in certain respective zones of the internal part 12 of that spar 10, provided with holes 17 for clipping in electrical harness fasteners (not shown).

In a variant not shown here, the body subframe can be designed differently, for example with a single seat crossmember.

Numerous other variants are also possible, and it should be remembered that the claimed invention is not limited to the embodiments described and shown, but also encompasses all variants of execution within the reach of the person skilled in the art.

1. A body subframe for a hybrid or electric motor vehicle, comprising a floor extending transversely between two subframe lateral spars and at least one seat crossmember fixed to the top of the said floor and extending transversely between said two lateral spars, to which it is fixed; each said lateral spar comprising:
an elongate hollow body of closed cross-section composed of an internal spar part and an external spar part secured together,
an inner reinforcement extending longitudinally along and inside its hollow body; and
an outer reinforcement fixedly attached to the outer face of a zone of said internal spar part located opposite said at least one seat crossmember.

2. The body subframe according to claim 1, characterized wherein the internal part of each said lateral spar has a cross-sectional profile in the shape of a recumbent U and comprises a lateral web and twoupper and lower plates extending away from said floor from this the lateral web, said outer reinforcement of each said lateral spar having a cross-sectional profile in the shape of an inverted L and comprising a lateral flange bearing against the outer face of said lateral web and an upper flange extending away from said floor from this the lateral web and bearing against the outer face of said upper plate.

3. The body subframe according to claim 2, wherein each lateral end of said at least one seat crossmember is attached to the corresponding lateral spar by means of tabs projecting transversely from said end and welded to the upper flange of the outer reinforcement of that spar.

4. The body subframe according to one claim 2, wherein the lateral flange of each said outer reinforcement extends vertically on either side of said floor over at least the majority of the height of the lateral web of the internal part of the corresponding lateral spar.

5. The body subframe according to one claim 1, wherein the outer reinforcement of each said lateral spar has cut-outs made in respective zones of the internal part of each lateral spar provided with attachment holes.

6. The body subframe according to of claim 1, wherein the outer reinforcement of each said lateral spar is obtained from a sheet.

7. The body subframe according to claim 1, wherein the inner reinforcement of each said lateral spar is formed by a metal section obtained by extrusion.

8. The body subframe according to claim 1, wherein the inner reinforcement of each said lateral spar has a honeycomb structure composed of an outer shell and a network of internal partitions crisscrossing the an interior volume of this the shell.

9. The body subframe according to claim 1, wherein the body subframe comprises two of said seat crossmembers spaced longitudinally apart from one another.

10. A motor vehicle comprising a body subframe according to claim 1.
